(19) United States
(12) Patent Application Publication
(10) Pub. No.: US 2005/0246064 A1
(43) Pub. Date: Nov. 3, 2005

(54) Method for detecting position errors using a motion detector

(76) Inventor: Gregory C. Smith, Ames, IA (US)

Correspondence Address: G. BRIAN PINGEL, BROWN, WINICK, GRAVES,;GROSS, BASKERVILLE AND SCHOENEBAUM, P.L.C., REGENCY WEST 5, 4500 WESTOWN PARKWAY, SUITE 277, WEST DES MOINES, IA, 50266, US

(21) Appl. No.: 11/117,821

(22) Filed: Apr. 29, 2005

Related U.S. Application Data
(60) Provisional application No. 60/566,245, filed on Apr. 29, 2004.

(51) Int. Cl. G06F 19/00

(52) U.S. Cl. 700/245

(57) ABSTRACT

The present invention is a method and system for detecting position errors in robotic motion According to the method, a Doppler motion detector unit is placed proximate a critical position of a robot. Signals from the Doppler motion detector unit are monitored. Robot position errors are detected in the robot at least partially based on the signals from the Doppler motion detector unit. The industrial robot can be halted upon detection of an error and/or an alarm signal can be activated. The system includes the robot, the detector with a low-pass filter and a control system operatively connected to the detector and low-pass filter.

### CROSS-REFERENCE TO RELATED APPLICATIONS

This application is based upon and claims the benefit of priority from Applicant's prior provisional patent application, application U.S. Ser. No. 60/566,245, filed Apr. 29, 2004, the entire contents of which are incorporated herein by reference.

### BACKGROUND OF THE INVENTION

1. Field of the Invention

The present invention relates to monitoring of industrial robots. More specifically, but not exclusively, the present invention relates to detecting position errors in industrial robots, especially in-process errors.

2. Description of the Related Art

3. Related Art

Most industrial robots can return repeatedly to the same location in space quite precisely; they typically meet published repeatability specifications on the order of 0.5 mm. On the other hand, most industrial robots cannot move as precisely to a specified (x, y, z) position in space; they typically meet published accuracy specifications roughly an order of magnitude higher (typically 10 mm or worse) (Owens, 1994).

In many cases, published repeatability specifications meet positioning accuracy needs in industrial robot applications, such as spot welding, spray painting, and assembly. However, published positioning accuracy specifications often do not meet industry needs, when using off-line programming rather than manual teaching methods. For example, spot welding operations generally require moderate positioning accuracy, while assembly operations generally require precise positioning accuracy.

To meet application positioning accuracy requirements, most robot users turn to off-line calibration to bring positioning accuracy close to robot repeatability levels (Owens, 1994). Off-line calibration generally consists of the following five steps:
1. Move the robot into several poses (positions and orientations).
2. Measure and record the precise 3D workspace coordinates of the robot tool center point (TCP) at each pose.
3. Read and record the corresponding position of the robot, from the robot controller, at each pose.
4. Use the differences between measured 3D workspace coordinates and corresponding positions read from the robot controller to correct the parameters in the kinematic model used by the controller to position the robot.
5. During robot operation, use the corrected kinematic model to compute adjusted positions in space and then command the robot to move to the adjusted positions (which causes the robot to move to the actual desired positions).

The number of calibration poses used and the corresponding link positions for each pose must be selected to provide the information needed to accurately compute the kinematic model parameters (Robinson, Orzechowski, James, & Smith, 1997). For example, Owens (1994) used 25 different poses, while Rocadas and McMaster (1997) used 50 different poses.

To measure pose positions precisely enough to complete calibration, robot manufacturers generally use expensive measurement devices, such as theodolites, coordinate measurement machines, or laser tracking systems (Mayer & Parker, 1994; Nakamura, Itaya, Yamamoto, & Koyama, 1995; Owens, 1994). Such systems generally cannot be used for calibrating robots in factory environments, due to cost and space limitations. However, re-calibration may be needed after robot repair, collisions with the workpiece or other objects in the workspace environment, or over time as encoders or servo systems drift (Owens, 1994).

As a result, prior research offers many low-cost systems for calibrating robots off-line within factory environments. Low-cost methods for measuring robot position during calibration include cables (Owens, 1994), cameras (van Albada, Lagerberg, & Visser, 1994), dial gauges (Xu & Mills, 1999), and trigger probes with constraint planes (Zhong & Lewis, 1995).

Calibration deals effectively with geometric errors, which reportedly account for 90% of positioning accuracy errors. In particular, calibration effectively removes differences in individual robot link lengths and differences in individual robot joint zero positions due to (Rocadas & McMaster, 1994; Owens, 1994):
1. Manufacturing tolerances,
2. Joint transducer offset, and
3. Joint axis misalignment.

Calibration cannot remove remaining non-geometric errors due to (Rocadas & McMaster, 1994):
1. Joint and link compliance,
2. Gear backlash, and
3. Varying inertia.

However, the magnitude of the remaining, non-geometric sources of position inaccuracy is on the order of robot repeatability, and is, therefore, generally ignored.

After calibration, industrial robots, run open-loop without additional control or intervention, have met the accuracy needs of most current industrial applications (spot welding, material handling, workpiece handling, and assembly).

When open-loop use of robots has not met a given industrial application's needs, closed-loop-control or passive compliance has been used. For example, for arc welding, laser-based vision systems have been used to locate and track welding seams (Agapakis, Katz, Friedman, & Epstein, 1990). For assembly, passive compliance devices, such as remote center compliance (RCC) devices, have been used to align components for mating (Bruyninckx et al., 2001; Boubekri & Sherif, 1990).

However, on-line sources of robot position error have been largely ignored. Collisions with the workpiece or other objects in the workplace environment, encoder errors, or servo drift can cause robot position to drift out of specification, leading to product faults, scrap, machine damage, and additional costs. Such in-process errors are generally not detected until product faults are detected during product inspection.

Generally, sensors and methods used for calibrating robots cannot be used for in-process monitoring, because the mechanisms interfere with in-process robot operation (e.g., cable measuring systems, cameras, pointers, and calibration plates) or do not work well during in-process operations. For example, laser and optical sensors are difficult to place, since their optical paths are easily blocked by work pieces or parts of the robot. In addition, smoke or sparks from welding, or fluids in other manufacturing processes, can interfere with proper laser and optical sensor operation.

Thus, typically, the only counter measures currently used to prevent in-process errors are regularly scheduled robot re-calibration or production line stops when product faults are detected in inspection. However, detecting product faults after they occur is costly. Regular calibration, when not needed, is also expensive. Shop-floor recalibration of a single robot can take up to six hours or more (Owens, 1994). The wasted manpower time spent is an unnecessary excess cost.

Therefore, it is a primary object, feature, or advantage of the present invention to improve upon the state of the art.

It is a further, object, feature, or advantage of the present invention to provide a simple, low-cost method for detecting in-process robot position errors.

It is a further, object, feature, or advantage of the present invention to provide a method for immediately halting a robot or signaling an alarm once a position error is detected.

Another object of the invention is to develop a model to accurately predict robot position errors.

An additional object of the present invention is to provide a model for predicting robot position errors that can indicate the direction and/or magnitude of the error.

Yet another, object, feature, or advantage of the present invention is to prevent product faults, machine damage, wasted resources, or other problems associated with robot position errors, particularly on-line errors.

These and/or other objects, features, or advantages of the present invention will become apparent from the specification that follows.

### SUMMARY OF THE INVENTION

The invention includes a simple, low-cost method and system for detecting in-process robot position errors. The method includes an on-line, non-contact method and system and uses a low-cost Doppler motion detector unit placed at one or more critical robot work positions and a low-pass filter to convert robot motion into electronic signals. These signals are then converted and processed using a computer. The small detector can be easily located near critical work positions. Motion signals from the motion detector unit (MDU) are monitored as a time series, and statistical quality control methods indicate when robot position drift or other process faults occur. Computer processing reduces captured signals into root sum of squares error measures, with respect to a mean calibration signal. Root sum of squares error measures are then compared to a threshold value that indicates, statistically, a 99.7% probability that a position error has occurred. The threshold value can be adjusted to meet different application needs including determining direction and magnitude of position errors.

When faults or robot position errors are detected, signals can be generated to halt the robot and trigger alarms. Alarms signal the need for robot service or re-calibration. Halting the robot at the earliest sign of possible position errors can help prevent product faults, scrap, machine damage, and additional costs.

Accurate in-process robot position error detection indicates the need for corrective action: homing, recalibration, or repair. The present invention offers advantages over other possible methods and systems. The sensor employed by the present invention uses a microwave Doppler radar detector, which is generally less expensive and/or more reliable in industrial environments than optical sensors, such as laser tracking systems or cameras. The present invention is generally more practical for in-process error detection than contact devices, such as cable systems, trigger probes, or dial gauges. The present invention may eliminate the need for regularly scheduled robot homing or recalibration, thus improving productivity. At the same time, the present invention identifies error conditions when they exist, reducing scrap, which also lowers costs and improves productivity.

According to another aspect of the present invention, a system for industrial work is disclosed. This system includes a robot and a Doppler motion detector proximate a critical robot work position. A control system is operatively connected to the Doppler motion detector unit. The control system is adapted for monitoring signals from the Doppler motion detector unit and detecting a fault in the industrial robot at least partially based on the signals from the Doppler motion detector unit.

Other objects, features, and advantages of the present invention will be readily appreciated as the same becomes better understood after reading the subsequent description taken in conjunction with the appendant drawings.

### BRIEF DESCRIPTION OF THE DRAWINGS

FIG. 1 illustrates a system according to the preferred embodiment of the present invention;

FIG. 2 illustrates a sensor circuit according to one embodiment of the present invention;

FIG. 3 provides an electronic schematic of one embodiment of the electronic filter of the present invention;

FIG. 4a is a flowchart showing the steps of the method of the present invention;

FIG. 4b illustrates a graph showing the magnitude of the electronic filter frequency response for the electronic filter shown in FIG. 3.

FIG. 5 provides a graph showing the dial gauge measurements (inches) versus robot T-axis position (degrees).

FIG. 6 shows a graph showing the calibration signals and the mean of the calibration signals.

FIG. 7 is a graph showing an expanded view of FIG. 6 near 2.5 seconds.

FIG. 8 is a graph showing error signals and the mean of the calibration signals.

FIG. 9 is a graph showing an expanded view of FIG. 8 near 2.5 seconds.

FIG. 10 is a graph showing RSSeᵢ versus robot workspace X-coordinate values.

FIG. 11 is a graph showing RSSeᵢ versus robot workspace X-coordinate values for position errors.

FIG. 12 is a graph showing RSSri versus robot workspace X-coordinate values.

### DETAILED DESCRIPTION OF THE PREFERRED EMBODIMENT

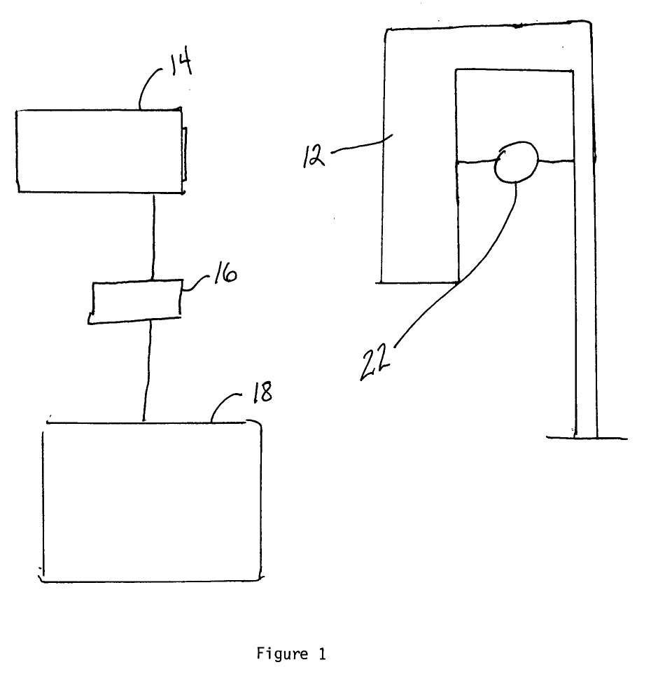

FIG. 1 shows a system embodying a robotic movement position error detection method of the present invention. Said system comprises a robot 12 which may have at least as many as four axis R (radial), T (rotational), Z (vertical), and A (gripper rotation). The preferred embodiment employs a Seiko D-TRAN RT-2000 robot having a cylindrical configuration with four axes.

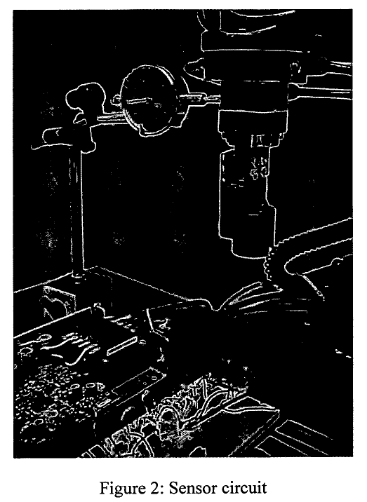

Said system further comprises a sensor circuit shown in FIG. 2 including a Doppler radar motion detector 14 and a low-pass electronic filter 16, and a control system 18 operatively connected to the Doppler motion detector 14 unit having a data collection system 20. The control system 18 comprises means for monitoring signals from the Doppler motion detector unit and detecting a position error in the robot at least partially based on the signals from the Doppler motion detector unit 14. For experimental development and validation of the system and method, a dial gauge 22 was also present.

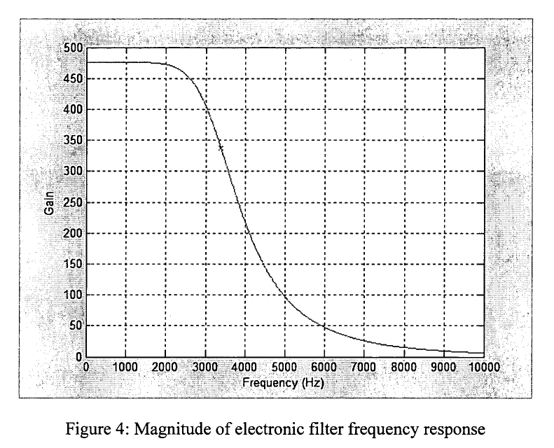

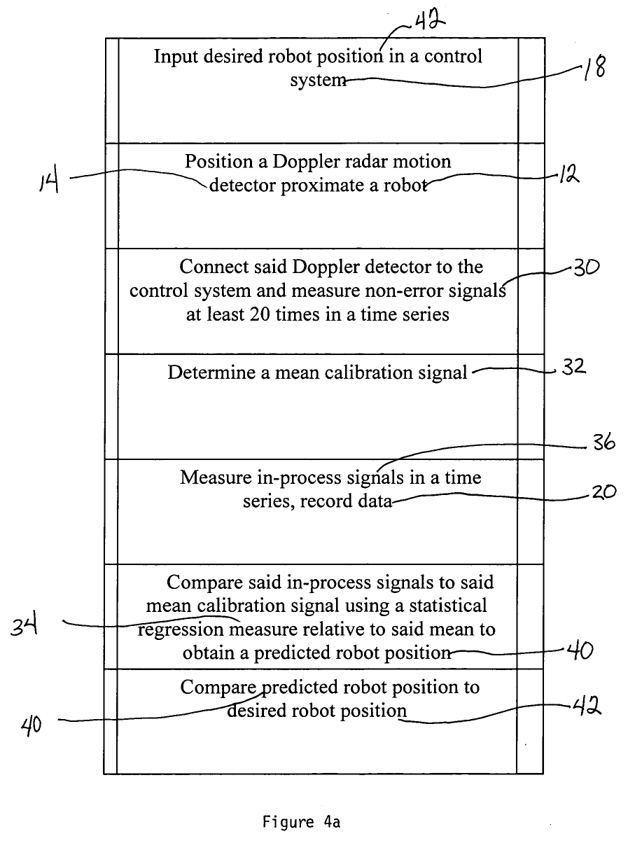

The method of the present invention comprises a series of steps shown in FIG. 4a. Said Doppler radar motion detector 14 is placed proximate a critical position of the robot 12 and actuated. A plurality of non-error signals 30 from the Doppler motion detector are monitored as a time series and recorded in said data collection system 20. A mean calibration signal 32 is calculated from said plurality of non-error signals and a statistical regression measure 34 relative to said mean calibration signal is determined. Next, a plurality of in-process signals 36 is generated by said Doppler radar motion detector 14 when said robot 12 is performing in-process motion and recorded by said data collection system 20. Said plurality of in-process signals 36 is compared to said mean calibration signal 32 using the statistical regression measure 34 relative to said mean. The output of the comparison is a predicted position value 40. Said predicted position value 40 is compared to a desired position value 42 and a difference indicates a robot position error 44. The robot position error 44 can be quantified as magnitude and/or direction.

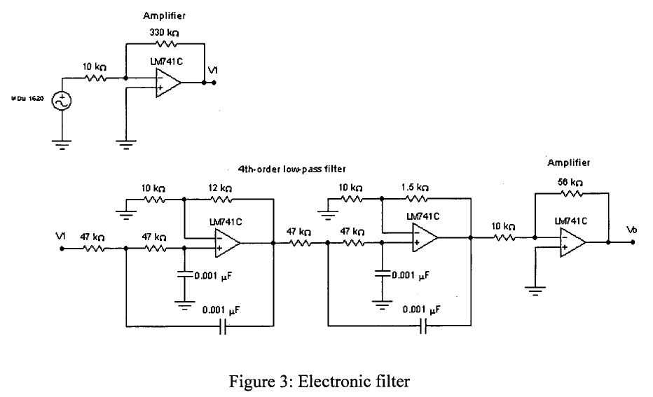

To prevent aliasing during sampling of said plurality of non-error signals or said plurality of in-process signals the low-pass electronic filter 16 is used to band-limit the signal from the Doppler radar motion detector 14 before sampling (See FIG. 3).

In a preferred embodiment, the method includes halting said robot upon detection of a robot position error and/or sounding an alarm indicating a robot position error was detected. As is well known in the art, most robots have control lines that provide input and output to and from the robot to a computer or other control device. Upon determination of a position error in the present invention, the control system switches the state of one of the input lines to the robot, which the robot reads at one or more points in the robot program, and stops if the input line indicates that an error took place. In another embodiment, upon determination of a position error, the control system acuates an alarm light or sound and an operator manually shuts down the robot.

For the experiments conducted, after robot homing, the robot was commanded to move from a home position to a test point in the robot workspace coordinate system. As shown in FIGS. 1 and 2, the dial gauge, with a scale in English units, was used to accurately measure relative robot positions around the given test position. FIG. 2 also shows the sensor circuit, which was developed for measuring robot motion. The preferred embodiment employs a model MDU 1620 Motion Detector Unit from Microwave Solutions.

After each command issued to move the robot from home position to the test position, an output signal from the Doppler motion detector/low-pass filter combination was measured for 4 seconds with a 0.1 msec sampling period (10 kHz sampling frequency). The sampled data was used to reconstruct frequency components up to 5 kHz in the original signal (Swanson, 2000).

FIG. 4 shows the theoretical frequency response of the electronic filter. To meet the sampling criterion, Swanson (2000) recommends using a band-limiting filter with an upper cut-off frequency which is roughly 0.4 times the sampling frequency. Captured data was analyzed using Math Works Matlab (Version 6.5.0.1924 Release 13) and SAS JMP 5.

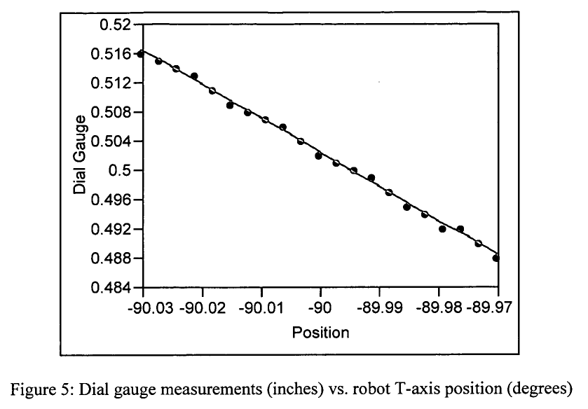

Five experiments were run to develop and test the present invention's method for detecting on-line robot position errors, for robot motions in a single axis direction. (See FIG. 5) However, the present invention contemplates detection of multi-axis robot position errors as well. Experiments 1 and 2 were run to verify that the robot used for testing met the manufacturer's published repeatability and resolution specifications, to verify that a dial gauge could be used to precisely measure robot position, and to characterize the drift characteristics of the robot over an extended period of cycling. Experiment 3 was run to develop a measure of robot position from sensor signals and to determine the precision of the sensor signal measure for robot moves to a single test position. Experiment 4 was run to establish a linear regression relationship between the robot position measure, which was developed in Experiment 3, and actual (induced) robot position errors. Experiment 5 was run to develop a robot position error detection model, from Experiment 3 and Experiment 4 results, and to test the prediction model for random robot moves about a single test position. The same experimental setup was used for all five experiments.

The results of each experiment were used to adjust subsequent experiments, if needed. Since an incremental methodology was used, intermediate conclusions are reported with results from each experiment.

### Experiment 1

The objectives of Experiment 1 were to:
1. Experimentally verify the repeatability of the Seiko D-TRAN RT-2000 robot used for testing,
2. Experimentally verify that a dial gauge could be used to precisely measure robot position, and
3. Experimentally determine if there is significant drift in the robot during cycling.

The method used to experimentally determine robot repeatability and drift characteristics consisted of five steps:
1. Command the robot to move to a test position 20 times,
2. Measure the position of the robot using a dial gauge,
3. Cycle the robot, between the workspace origin and the test position, for 3 hours,
4. Command the robot to move to the test position 20 times.

5. Measure the position of the robot using a dial gauge.

TABLE 2
Robot position dial gauge measurements for Experiment 1

| Step | Before Cycling (inches) | After Cycling (inches) |
|---|---|---|
| 0 | 0.501 | — |
| 1 | 0.503 | 0.501 |
| 2 | 0.503 | 0.502 |
| 3 | 0.502 | 0.501 |
| 4 | 0.503 | 0.501 |
| 5 | 0.503 | 0.501 |
| 6 | 0.503 | 0.501 |
| 7 | 0.502 | 0.502 |
| 8 | 0.503 | 0.503 |
| 9 | 0.502 | 0.501 |
| 10 | 0.502 | 0.502 |
| 11 | 0.502 | 0.502 |
| 12 | 0.503 | 0.502 |
| 13 | 0.502 | 0.502 |
| 14 | 0.503 | 0.501 |
| 15 | 0.502 | 0.502 |
| 16 | 0.503 | 0.501 |
| 17 | 0.503 | 0.502 |
| 18 | 0.502 | 0.501 |
| 19 | 0.502 | 0.501 |
| 20 | 0.502 | 0.502 |

Table 2 shows robot position dial gauge measurements taken at the test position before and after cycling the robot for 3 hours. Step 0, in Table 2, indicates the initial position to which the dial gauge was set, with the robot resting at the correct test position.

A one-way analysis of variance between the two groups of data shows that there is evidence of a statistically significant difference between the two group means (α=0.05, p-value<0.001). The mean for the Before Cycling group is 0.50243 inches (with a 95% confidence interval of 50216-0.50270 inches), and the mean for the After Cycling group is 0.501550 inches (with a 95% confidence interval of 0.50127-0.50183 inches). The difference between the two means is 0.00088 inches. With 95% confidence, a reasonable value for the difference between means lies between 0.00050 and 0.00126 inches. For the given robot, a reasonable value for the difference between robot position means, before and after 3 hours of cycling, lies between 0.00050 and 0.00126 inches. Experiment 1 results indicate that:
1. The robot appears to meet Seiko's published repeatability specification (0.025 mm or 0.001 inch), for measurements taken at a single time instance (before cycling or after cycling).
2. The dial gauge can be used to measure robot position precisely, (within approximately the robot repeatability specification).
3. There is evidence that the robot may drift slightly with extended cycling (3 hours). The upper limit of the 95% confidence interval for the difference between before cycling and after cycling means (0.00126 inches) is greater that the robot repeatability specification (0.001 inch), indicating that, with 95% confidence, a drift of 0.00026 inches beyond the robot repeatability specification could occur. As a result, an online method for detecting position errors might be useful for the given robot.

For Experiments 2-5, robot position errors were simulated by commanding the robot to move to positions slightly away from the test position.

### Experiment 2

The objective of Experiment 2 was to:
1. Experimentally verify that the dial gauge could accurately detect single-axis robot position errors, for the given robot.

The method used to experimentally verify that the dial gauge could accurately detect single-axis position errors consisted of two steps:
1. Command the robot to move to the test position±0.03 T-axis degrees, in 0.003 degree increments (the robot's T-axis accuracy specification is 0.003 degrees, which corresponds to 0.001 inches at the given test position).
2. Measure the position of the robot using the dial gauge.

Table 3 shows the 21 positions about the test point to which the Seiko D-TRAN RT-2000 robot was commanded to move (values in millimeters), as well as the corresponding dial gauge measurements (in inches).

TABLE 3
Robot position dial gauge measurements for Experiment 2

| | Position | X | Y | Dial Gauge |
|---|---|---|---|---|
| Step | (degrees) | (mm) | (mm) | (inches) |
| 1 | −89.970 | 0.313 | −597.056 | 0.488 |
| 2 | −89.973 | 0.281 | −597.056 | 0.490 |
| 3 | −89.976 | 0.250 | −597.056 | 0.492 |
| 4 | −89.979 | 0.219 | −597.056 | 0.492 |
| 5 | −89.982 | 0.188 | −597.056 | 0.494 |
| 6 | −89.985 | 0.156 | −597.056 | 0.495 |
| 7 | −89.988 | 0.125 | −597.056 | 0.497 |
| 8 | −89.991 | 0.094 | −597.056 | 0.499 |
| 9 | −89.994 | 0.063 | −597.056 | 0.500 |
| 10 | −89.997 | 0.031 | −597.056 | 0.501 |
| 11 | −90.000 | 0.000 | −597.056 | 0.502 |
| 12 | −90.003 | −0.031 | −597.056 | 0.504 |
| 13 | −90.006 | −0.063 | −597.056 | 0.506 |
| 14 | −90.009 | −0.094 | −597.056 | 0.507 |
| 15 | −90.012 | −0.123 | −597.056 | 0.508 |
| 16 | −90.015 | −0.156 | −597.056 | 0.509 |
| 17 | −90.018 | −0.188 | −597.056 | 0.511 |
| 18 | −90.021 | −0.219 | −597.056 | 0.513 |
| 19 | −90.024 | −0.250 | −597.055 | 0.514 |
| 20 | −90.027 | −0.281 | −597.055 | 0.515 |
| 21 | −90.030 | −0.313 | −597.055 | 0.516 |

an analysis of variance shows evidence of a statistically significant relationship measurements and degree values (α=0.05, p-value<0.0001). Equation 1 gives the equation of the least squares line shown in FIG. 5:
Predicted dial gauge value=−41.69−0.4688*Robot position (1)

The model explains 99.74% of the variability in dial gauge measurements. Random measurement errors or other unexplained factors account for only a small amount of the observed variability in the data.

Experiment 2 results indicate that:
1. The Seiko D-TRAN RT-2000 robot appears to meet the published T-axis resolution specification (0.003 degrees). In other words, the robot can be accurately commanded to positions that differ by as little as 0.003 degrees.
2. The dial gauge can be used to detect given robot position errors to approximately the T-axis resolution specification.

Based upon Experiment 2 results, the given experimental setup was used for the remaining planned experiments.

### Experiment 3

The objectives of Experiment 3 were to:
1. Develop a measure from sensor signal samples for determining robot position,
2. Determine how well the sensor signal measure represents robot position, and
3. Establish a mean signal to represent the robot moving to the correct test position.

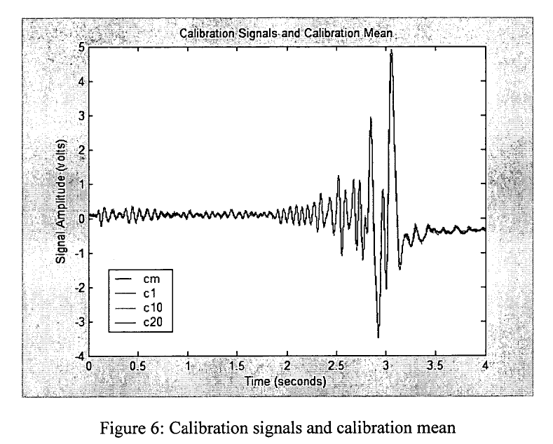

The method used to experimentally achieve Experiment 3 objectives consisted of six steps:
1. Cycle the robot 20 times between home position and the nominal test position.
2. Measure robot position with the dial gauge.
3. Measure the sensor signal as the robot moves between home and the nominal test position. Sample the sensor signal at 0.1 msec intervals.
4. Average the values of the 20 sensor signals at each sampling time step to find the mean calibration sensor signal value at each sampling time step. (See FIG. 6)
5. Compute a root sum of squares error measure for each of the 20 sensor signals by summing squared error for each time sample with respect to the mean calibration sensor signal value at each sampling time sample.
6. Compare standard deviation of the root sum of squares error measure for the 20 sensor signals to standard deviation of the 20 dial gauge readings.

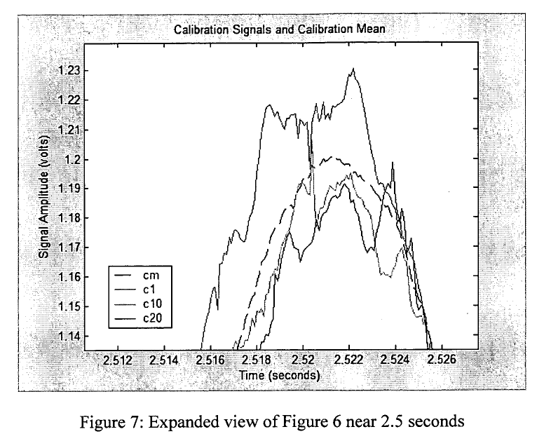

FIG. 6 shows three representative sensor calibration signals, Cᵢ and the mean calibration signal cₘ. FIG. 7 shows an expanded view of FIG. 6 in the region near 2.5 seconds. The signals in FIGS. 6 and 7 were filtered to remove any DC bias. The mean value of each signal was computed and subtracted from each of the signal's sample values.

A frequency spectrum computed for calibration signal c₁₀ shows that the sensor output signals for robot motion between home position and the test position are band limited to frequencies less than approximately 25 Hz. Therefore, the sampling period (0.1 msec) was more than adequate for accurately capturing signal content without aliasing.

To meet Experiment 3 objectives, each of the 20 filtered calibration signals were represented as an array of real numbers
cᵢ(n), i=1Λ 20; n32 1Λ 40000 (2)

The mean calibration signal value of all 20 signals at any given sample time step was calculated

$${c}_{m} ( n ) = \frac{1}{20} {\sum }_{i = 1}^{20} {c}_{i} ( n ) \qquad ( 3 )$$

As a measure of individual signal variation with respect to the mean of all 20 signals, a root sum of squares error measure was computed for the 10,001 samples between 2.5 and 3.5 seconds

$${RSSc}_{i} = \sqrt{{\sum }_{n = 25000}^{35000} {[ {c}_{i} ( n ) - {c}_{m} ( n ) ]}^{2}} \qquad ( 4 )$$

The 10,001 samples between 2.5 and 3.5 seconds were used, rather than all 40,000 samples, to reduce computation time and to improve signal-to-noise ratio. Table 4 shows the 20 RSScᵢ measurements and the 20 corresponding dial gauge measurements taken for Experiment 3.

TABLE 4
Error measures for calibration signals

| Signal | RSScᵢ | Dial Gauge (inches) |
|---|---|---|
| c₁ | 11.2241 | 0.500 |
| c₂ | 3.2244 | 0.499 |
| c₃ | 2.7502 | 0.500 |
| c₄ | 3.2171 | 0.500 |
| c₅ | 2.9028 | 0.500 |
| c₆ | 2.3334 | 0.500 |
| c₇ | 1.9100 | 0.500 |
| c₈ | 1.3153 | 0.501 |
| c₉ | 1.9060 | 0.500 |
| c₁₀ | 2.4277 | 0.500 |
| c₁₁ | 2.1314 | 0.500 |
| c₁₂ | 1.9294 | 0.500 |
| c₁₃ | 2.1702 | 0.501 |
| c₁₄ | 2.5620 | 0.500 |
| c₁₅ | 2.5384 | 0.500 |
| c₁₆ | 3.0110 | 0.501 |
| c₁₇ | 2.9737 | 0.501 |
| c₁₈ | 3.3289 | 0.500 |
| c₁₉ | 2.7221 | 0.500 |
| c₂₀ | 2.9593 | 0.500 |

An analysis of variance indicates that there is no statistically significant relationship between RSScᵢ, and dial gauge measurements (α=0.05, p-value=0.5462). The analysis of variance indicates that, with 95% confidence, variation in both measures is probably due to random measurement error.

Experiment 3 results indicate that:
1. The RSScᵢ, measure, for the 20 calibration signals, appears to be relatively repeatable.
2. If the sample of 20 calibration signals accurately represents the population of all sensor signals produced by the robot moving to the given test position, the RSScᵢ, measure developed may be usable for detecting robot position errors, using statistical \overline{X} control chart techniques.

For the RSScᵢ measure to be useable as an \overline{X} chart quality measure, when errors occur, individual RSS measures, on average, must lie at least three standard deviations from the mean calibration signal value for the 20 calibration signals (9.01 or larger) (Besterfield, 2001). On average, there appears to be a significant difference between the \overline{X} chart error detection threshold and the RSScᵢ measure, for most of the calibration signals.

### Experiment 4

The objectives of Experiment 4 were to:
1. Determine the feasibility of using sensor signals to detect robot position errors, and
2. Experimentally establish a relationship between position errors and sensor signals.

The method used to achieve Experiment 4 objectives consisted of three steps:
1. Command the robot to move from the home position±0.03 T-axis degrees to the test position±0.03 T-axis degrees, in 0.003 degree increments (the robot's T-axis accuracy specification is 0.003 degrees).
2. Measure the position of the robot using a dial gauge.
3. Simultaneously measure the signal (eᵢ) generated by the sensor.

The robot was commanded to move from offset positions about the home position to offset positions about the test position to simulate position errors that would occur due to collisions with the workpiece or other objects in the workplace environment, encoder errors, or servo drift. The robot was commanded to move incrementally to 21 positions about, and including, the test position

Data collected from Experiment 3 and Experiment 4 was analyzed using statistical methods to establish a relationship between position errors and sensor signals. The resulting relationship was then used to detect or predict on-line robot position errors (Experiment 5).

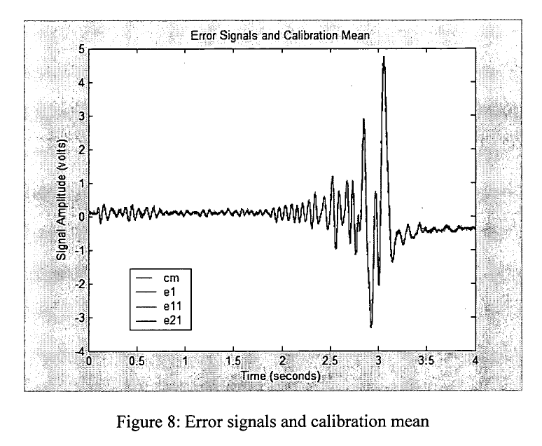

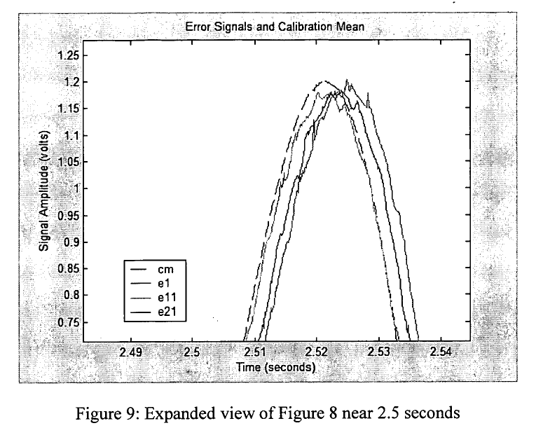

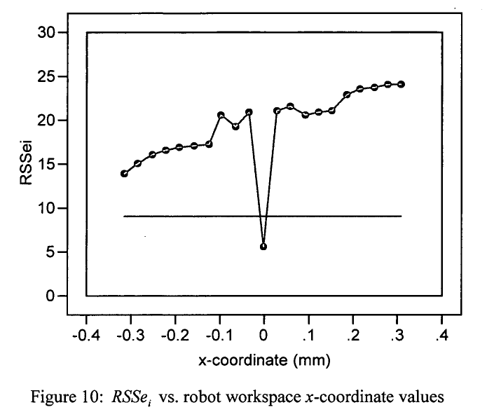

FIG. 8 shows three representative sensor error signals, eᵢ and the mean calibration signal cₘ. FIG. 9 shows an expanded view of FIG. 8 in the region near 2.5 seconds. Table 5 shows the 21 positions from which the robot was commanded to move, the 21 positions to which the robot was commanded to move, and the corresponding final robot workspace x-coordinate values to which the robot was commanded to move. Table 5 also shows the 21 resulting RSSeᵢ measurements and the 21 corresponding dial gauge measurements for Experiment 4. FIG. 10 shows the 21 RSSeᵢ measurements plotted as a function of the 21 corresponding final robot workspace x-coordinate values to which the robot was commanded to move. FIG. 10 also shows the RSSeᵢ error detection limit established in Experiment 3 (9.01). RSSeᵢ, measurements were calculated using the procedure described for Experiment 3:

$${RSSe}_{i} = \sqrt{{\sum }_{n = 25000}^{35000} {[ {e}_{i} ( n ) - {c}_{m} ( n ) ]}^{2}} \qquad ( 5 )$$

TABLE 5
RSSeᵢ and dial gauge measurements for Experiment 4

| | | | | | Dial |
|---|---|---|---|---|---|
| | From | To | x-coordinate | | Gauge |
| Signal | (degrees) | (degrees) | (mm) | RSSeᵢ | (inches) |
| e₁ | 0.030 | −89.970 | 0.313 | 24.1117 | 0.487 |
| e₂ | 0.027 | −89.973 | 0.281 | 24.0249 | 0.489 |
| e₃ | 0.024 | −89.976 | 0.250 | 23.7619 | 0.489 |
| e₄ | 0.021 | −89.979 | 0.219 | 23.5060 | 0.491 |
| e₅ | 0.018 | −89.982 | 0.188 | 22.8818 | 0.493 |
| e₆ | 0.015 | −89.985 | 0.156 | 21.1411 | 0.494 |
| e₇ | 0.012 | −89.988 | 0.125 | 20.9980 | 0.496 |
| e₈ | 0.009 | −89.991 | 0.094 | 20.6291 | 0.497 |
| e₉ | 0.006 | −89.994 | 0.063 | 21.6124 | 0.498 |
| e₁₀ | 0.003 | −89.997 | 0.031 | 21.0818 | 0.500 |
| e₁₁ | 0.000 | −90.000 | 0.000 | 5.6112 | 0.501 |
| e₁₂ | −0.003 | −90.003 | −0.031 | 20.9378 | 0.503 |
| e₁₃ | −0.006 | −90.006 | −0.063 | 19.1932 | 0.504 |
| e₁₄ | −0.009 | −90.009 | −0.094 | 20.5077 | 0.506 |
| e₁₅ | −0.012 | −90.012 | −0.123 | 17.2669 | 0.507 |
| e₁₆ | −0.015 | −90.015 | −0.156 | 17.1234 | 0.508 |
| e₁₇ | −0.018 | −90.018 | −0.188 | 16.9160 | 0.509 |
| e₁₈ | −0.021 | −90.021 | −0.219 | 16.6139 | 0.511 |
| e₁₉ | −0.024 | −90.024 | −0.250 | 16.0514 | 0.512 |
| e₂₀ | −0.027 | −90.027 | −0.281 | 15.0220 | 0.514 |
| e₂₁ | −0.030 | −90.030 | −0.313 | 13.9787 | 0.516 |

FIG. 9 shows that sensor signals for both positive and negative final robot workspace x-coordinate values lag the calibration mean cₘ, whereas eₗₗ, the signal 10 generated when the robot moves without offset from the home and test positions, closely matches the calibration mean.

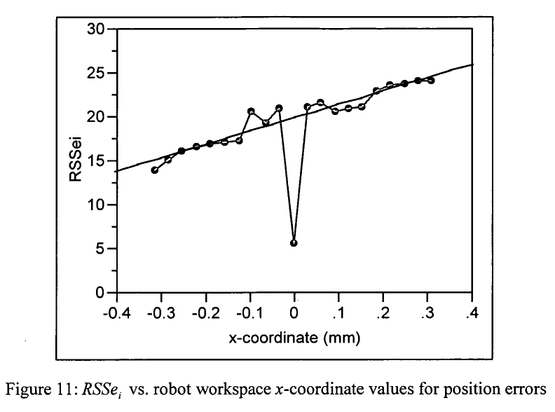

FIG. 10 shows that the RSSeᵢ measures calculated for any of the offset robot motions exceed the single-point error limit established in Experiment 3. The method detects any induced robot position errors, to the repeatability specification of the robot. In addition, by excluding the point in FIG. 10 corresponding to eₗₗ, the non-error condition signal, an analysis of variance shows evidence of a statistically significant relationship between RSSeᵢ measurements and commanded final x-coordinate values (α=0.05, p-value<0.0001). Equation 6 gives the equation of the least squares line shown in FIG. 11:
Predicted RSSeᵢ=19.87+15.31*x-coordinate (6)

Experiment 4 results indicate that:
1. Sensor signals can be used to detect single-axis robot position errors at robot repeatability levels.
2. There is evidence of a statistically significant relationship between the error measure developed and actual robot position error. The relationship allows not only detecting robot position errors, but also determining the directions and magnitudes of errors.

### Experiment 5

The objective of Experiment 5 was to:
1. Test the robot position error detection model developed in Experiment 4.

The method used to test the error detection model consisted of six steps:
1. Command the robot to move from the home position±0.03 T-axis degrees to the test position±0.03 T-axis degrees, in 0.003 degree increments, and in random order.
2. For each move, measure the position of the robot using a dial gauge.
3. Simultaneously measure the signal (rᵢ) generated by the sensor.
4. Calculate the error detection measure (RSSrᵢ) for the given sensor signal.
5. For each output signal, use the developed error detection model to predict whether or not the robot was in an error condition.
6. Compare error detection model predictions to actual robot positions to determine the system's capability for detecting position errors.

Table 6 shows the 21 positions from which the robot was commanded to move, the 21 positions to which the robot was commanded to move, and the corresponding final robot workspace x-coordinate values to which the robot was commanded to move. Table 6 also shows the 21 resulting RSSrᵢ, measurements and the 21 corresponding dial gauge measurements.

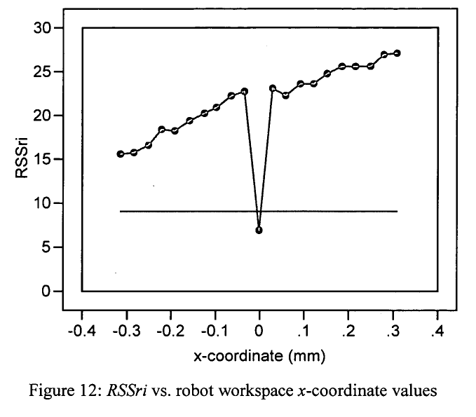

FIG. 12 shows the 21 RSSrᵢ measurements plotted as a function of the 21 corresponding final robot workspace x-coordinate values to which the robot was commanded to move. FIG. 12 also shows the RSSeᵢ error detection limit established in Experiment 3 (9.01). RSSrᵢ measurements were calculated using the procedure described for Experiment 3:

$${RSSr}_{i} = \sqrt{{\sum }_{n = 25000}^{35000} {[ {r}_{i} ( n ) - {c}_{m} ( n ) ]}^{2}} \qquad ( 7 )$$

TABLE 6
RSSrᵢ and dial gauge measurements for Experiment 5

| | | | | | Dial |
|---|---|---|---|---|---|
| | From | To | x-coordinate | | Gauge |
| Signal | (degrees) | (degrees) | (mm) | RSSrᵢ | (inches) |
| r₁ | −0.030 | −90.030 | −0.313 | 15.5917 | 0.515 |
| r₂ | 0.000 | −90.000 | 0.000 | 6.9508 | 0.502 |
| r₃ | −0.027 | −90.027 | −0.281 | 15.8215 | 0.514 |
| r₄ | −0.015 | −90.015 | −0.156 | 19.4724 | 0.508 |
| r₅ | −0.024 | −90.024 | −0.250 | 16.5845 | 0.513 |
| r₆ | 0.018 | −89.982 | 0.188 | 25.6551 | 0.493 |
| r₇ | 0.021 | −89.979 | 0.219 | 25.6022 | 0.491 |
| r₈ | 0.027 | −89.973 | 0.281 | 26.9904 | 0.489 |
| r₉ | −0.021 | −90.021 | −0.219 | 18.4504 | 0.511 |
| r₁₀ | −0.018 | −90.018 | −0.188 | 18.2697 | 0.510 |
| r₁₁ | 0.006 | −89.994 | 0.063 | 22.2440 | 0.498 |
| r₁₂ | 0.012 | −89.988 | 0.125 | 23.5641 | 0.496 |
| r₁₃ | 0.030 | −89.970 | 0.313 | 27.1052 | 0.488 |
| r₁₄ | 0.024 | −89.976 | 0.250 | 25.5870 | 0.491 |
| r₁₅ | −0.003 | −90.003 | −0.031 | 22.8124 | 0.504 |
| r₁₆ | 0.009 | −89.991 | 0.094 | 23.5282 | 0.498 |
| r₁₇ | −0.009 | −90.009 | −0.094 | 20.8457 | 0.506 |
| r₁₈ | −0.012 | −90.012 | −0.123 | 20.3149 | 0.506 |
| r₁₉ | −0.006 | −90.006 | −0.063 | 22.2316 | 0.504 |
| r₂₀ | 0.015 | −89.985 | 0.156 | 24.6732 | 0.494 |
| r₂₁ | 0.003 | −89.997 | 0.031 | 23.0340 | 0.501 |

From Equation 6,
RSSrᵢ₌19.87+15.31* x-coordinate (8)

Therefore, the x-coordinate of the final robot position can be predicted:

$$Predicted x \text{-} coordinate = \frac{{RSSr}_{i} - 19.87}{15.31} = - 1.298 + 0.0653 * {RSSr}_{i} \qquad ( 9 )$$

Finally, from the x-coordinate prediction, the direction and magnitude of the single-axis robot position error can also be predicted. Negative x-coordinate values indicate that the robot moved past the desired position; positive x-coordinate values indicate that the robot did not reach the desired position (with respect to the home position). The difference between the predicted and desired x-coordinate indicates the magnitude of the position error.

Table 7 shows commanded (actual) and predicted x-coordinate values for Experiment 5. Table 7 also shows actual errors and predicted errors, whether or not the direction (sign) of the predicted error is correct, and the difference between the predicted error magnitude and the actual (induced) error magnitude (errors due to the prediction model).

Experiment 5 results show that:

1. The robot position error detection model developed in Experiment 4 predicts Experiment 5 errors with 100% accuracy, error direction with 81% accuracy, and error magnitude to within 0.223 mm.

TABLE 7
Predicted vs. actual errors

| | Actual | Predicted | | | | |
|---|---|---|---|---|---|---|
| | x-coordinate | x-coordinate | Actual | Predicted | Sign | Model |
| Signal | (mm) | (mm) | Error | Error | Correct | Error (mm) |
| r₁ | −0.313 | −0.2794 | Yes | Yes | Yes | 0.034 |
| r₂ | 0.000 | 0.0000 | No | No | Yes | 0.000 |
| r₃ | −0.281 | −0.2644 | Yes | Yes | Yes | 0.017 |
| r₄ | −0.156 | −0.0260 | Yes | Yes | Yes | 0.130 |
| r₅ | −0.250 | −0.2146 | Yes | Yes | Yes | 0.035 |
| r₆ | 0.188 | 0.3779 | Yes | Yes | Yes | 0.190 |
| r₇ | 0.219 | 0.3744 | Yes | Yes | Yes | 0.155 |
| r₈ | 0.281 | 0.4651 | Yes | Yes | Yes | 0.184 |
| r₉ | −0.219 | −0.0927 | Yes | Yes | Yes | 0.126 |
| r₁₀ | −0.188 | −0.1045 | Yes | Yes | Yes | 0.084 |
| r₁₁ | 0.063 | 0.1551 | Yes | Yes | Yes | 0.092 |
| r₁₂ | 0.125 | 0.2413 | Yes | Yes | Yes | 0.116 |
| r₁₃ | 0.313 | 0.4726 | Yes | Yes | Yes | 0.160 |
| r₁₄ | 0.250 | 0.3734 | Yes | Yes | Yes | 0.123 |
| r₁₅ | −0.031 | 0.1922 | Yes | Yes | No | 0.223 |
| r₁₆ | 0.094 | 0.2389 | Yes | Yes | Yes | 0.145 |
| r₁₇ | −0.094 | 0.0637 | Yes | Yes | No | 0.158 |
| r₁₈ | −0.123 | 0.0291 | Yes | Yes | No | 0.152 |
| r₁₉ | −0.063 | 0.1543 | Yes | Yes | No | 0.217 |
| r₂₀ | 0.156 | 0.3137 | Yes | Yes | Yes | 0.158 |
| r₂₁ | 0.031 | 0.2067 | Yes | Yes | Yes | 0.176 |

Experiment 5 results indicate that the method developed can reliably identify robot position errors at robot repeatability levels. The method can also identify the direction of an error relative to the desired position and the magnitude of the error.

The present invention contemplates numerous variations. For example, the proposed method may be improved by using standard \overline{X} control chart techniques, including subgroup sampling and averaging. The present invention contemplates numerous variations including:
1. Variations in sensor design,
2. Variations in sensor placement,
3. Detecting multi-axis position errors by choosing different sensor placement strategies or by using multiple sensors at a given position,
4. Fully automating the data collection and analysis process, and
5. Using control chart techniques to improve error detection capabilities, particularly error direction and error magnitude prediction capabilities.

These and other variations are well within the spirit and scope of the invention.

The present invention offers advantages over other possible methods and systems. The sensor developed uses a microwave Doppler radar detector, which is generally less expensive and/or more reliable in industrial environments than optical sensors, such as laser tracking systems or cameras. The present invention is generally more practical for in-process error detection than contact devices, such as cable systems, trigger probes, or dial gauges. The present invention may eliminate the need for regularly scheduled robot homing or recalibration, thus improving productivity. At the same time, the present invention identifies error conditions when they exist, reducing scrap, which also lowers costs and improves productivity.

Therefore, a method and system for detecting industrial robot position errors have been disclosed. One skilled in the art and having the benefit of this disclosure will recognize that the present invention contemplates numerous variations and is not limited to what is specifically described herein.

1. A method for detecting position errors in robotic movement, comprising:
placing a Doppler motion detector unit proximate a critical position of the robot;
monitoring a plurality of in-process signals from the Doppler motion detector unit; detecting a robot position error in the robot at least partially based on a comparison of the plurality of in-process signals to a mean calibration signal.

2. The method of claim 1 wherein said plurality of in-process signals are monitored as a time series.

3. The method of claim 1 wherein said mean calibration signal is the result of averaging a plurality of non-error signals.

4. The method of claim 1 further comprises halting the robot after detecting the robot position error.

5. The method of claim 1 further comprising signaling an alarm after detecting the robot position error.

6. The method of claim 1 wherein the step of monitoring signals occurs while the robot is performing work.

7. The method of claim 1 wherein said comparison comprises generating a statistical regression measure relative to said mean calibration signal and said comparison yields a predicted position value and said method further comprises the step of comparing said predicted position value with a desired position value to detect said robot position error.

8. The method of claim 7 wherein a mathematical difference between said desired position value and said predicted position value provides a measure of the magnitude of robot position error.

9. The method of claim 1 further comprising quantifying an error direction associated with the position error.

10. The method of claim 3 further comprising quantifying an error magnitude associated with the position error.

11. A system, comprising:
a) a robot;
b) a Doppler motion detector unit proximate a critical position of the robot; and
c) a control system operatively connected to the Doppler motion detection unit for monitoring a plurality of in-process signals from the Doppler motion detector unit and detecting a robot position error in the robot at least partially based on the plurality of in-process signals from the Doppler motion detector unit by comparing said plurality of in-process signals to a mean calibration signal.

12. The system of claim 11 wherein the control system provides for detecting the robot position error while the robot is performing work.

13. The system of claim 11 further comprising an electronic low-pass filter to prevent aliasing during sampling of said plurality of in-process signals.

14. The system of claim 11 wherein the control system is further adapted to quantify an error direction of the position error.

15. The system of claim 11 wherein the control system is further adapted to quantify an error magnitude associated with the position error.

16. A method for detecting position errors in robotic movement comprising:
a) placing a Doppler radar motion detector proximate a critical position of a robot and actuating said detector;
b) monitoring a plurality of non-error signals from the Doppler motion detector as a time series and recording said plurality of non-error signals;
c) computing a mean calibration signal from said plurality of non-error signals by averaging the time series associated with each of the non-error signals;
d) monitoring a plurality of in-process signals;
e) using a statistical regression measure relative to the mean calibration signal comparing said plurality of in-process signals to determine a predicted robot position; and
f) comparing said predicted robot position with a desired robot position.
